(19) United States
(12) Patent Application Publication
(10) Pub. No.: US 2003/0126404 A1
(43) Pub. Date: Jul. 3, 2003

(54) Data processing system, array-type processor, data processor, and information storage medium

(75) Inventors: Kenichiro Anjo, Tokyo (JP); Taro Fujii, Tokyo (JP); Koichiro Furuta, Tokyo (JP); Yoshikazu Yabe, Tokyo (JP); Masato Motomura, Tokyo (JP); Takao Toi, Tokyo (JP); Toru Awashima, Tokyo (JP); Noritsugu Nakamura, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/326,966

(22) Filed: Dec. 24, 2002

(30) Foreign Application Priority Data
Dec. 26, 2001 (JP) 2001-394526

(51) Int. Cl. G06F 15/00

(52) U.S. Cl. 712/15

(57) ABSTRACT

At least one of a plurality of data processors of a data processing system is an array-type processor, and the data processing of this array-type processor and the other data processors is effectively linked. The array-type processor and other data processors, which process the process data in accordance with event data and issue event data in accordance with this data processing, communicate to each other at least a portion of the process data and at least a portion of the event data and thus link the data processing.

### BACKGROUND OF THE INVENTION

1. Field of the Invention

The present invention relates to a data processing system that allocates data processing to a plurality of data processors that are connected in parallel, and more particularly to a data processing system in which at least one of a plurality of data processors is constituted by an array-type processor.

2. Description of the Related Art

Products such as CPUs (Central Processing Units) or MPUs (Micro Processor Units) are now becoming practical as data processors that can freely execute various types of data processing.

Further, data processing systems in which complex data processing is allocated to a plurality of data processors that are parallel-connected are also coming into practical use, this type of data processing system including the homogenous-connection type in which a plurality of data processors of identical construction are connected and a heterogeneous-connection type in which a plurality of data processors of different construction are connected.

In a data processing system of the homogeneous-connection type, one case of data processing is divided between a plurality of data processors of the same construction, and data processing can therefore be executed with a high degree of parallelism. In a data processing system of the heterogeneous-connection type, one case of data processing is divided between data processors of a plurality of types, and each data processor can therefore execute the data processing for which it is best suited.

Data processors such as the MPU that are used in this type of data processing system can execute various types of data processing according to software but must successively execute a series of data processing in order. Achieving high speed when executing complex data processing has been difficult because instruction codes must be read for each of these successive processes.

On the other hand, a logical circuit that is formed by hardware directed to a single data process is capable of executing data processing at high speed, but because the software cannot be altered, such a logical circuit is capable of executing only one data process. To solve this problem, the present applicants have proposed an array-type processor as a data processor in which the configuration of the data path varies according to software, and have applied for patents as Japanese Patent Application 2000-043202 (Japanese Patent Laid-Open No. 2001-236385) and Japanese Patent Application 2001-263804, and Japanese Patent Application 2001-294241. In this array-type processor, a plurality of small-scale processor elements and a plurality of switch elements are arranged in a matrix in a data path unit, and one state managing unit is provided along with this data path unit.

The plurality of processor elements individually execute data processing in accordance with instruction codes that are set for each processor element, and the plurality of switch elements individually switch-control the connection relations of the plurality of processor elements in accordance with instruction codes that are set for each switch element.

In other words, by altering the configuration of the data path by switching the instruction codes of the plurality of processor elements and the plurality of switch elements, the array-type processor is capable of executing various types of data processing according to software; and because, as hardware, a plurality of processor elements of small scale execute simple data processing in parallel, the array-type processor is capable of executing data processing at high speed.

The state management unit successively switches, with each operation cycle and in accordance with a computer program, contexts that are constituted by the instruction codes of the above-described plurality of processor elements and the plurality of switch elements, and the array-type processor is thus capable of executing parallel processing continuously in accordance with a computer program. The present applicants originated the idea of applying the above-described array-type processor to a data processing system in which a plurality of data processors are connected in parallel.

However, because an array-type processor differs fundamentally both in constitution and operation from a data processor of the prior art, the above-described array type processor cannot be simply applied to a data processing system in which a plurality of data processors are connected in parallel; and even if the above-described array-type processor were simply applied, it would not be possible to realize effective distribution and linking of data processing between the array-type processor and the other data processors.

In addition, the large amount of processing data used in the above-described data processing system necessitates that, for example, a large-capacity data memory be connected with the plurality of data processors to a common external bus. However, this simply results in an increase in circuit scale and a consequent degradation of the efficiency of the use of the hardware.

### SUMMARY OF THE INVENTION

The present invention was realized in view of the above-described problems, and has as an object the provision of a data processing system that operates effectively with an array-type processor as at least one of a plurality of data processors that are connected in parallel.

The first data processing system of the present invention:

is a data processing system in which a plurality of data processors are connected in parallel, these data processors performing processing, in accordance with a computer program that has been set beforehand and event data that are received as input, of process data that have been received as input; this data processing system distributing the process data among this plurality of data processors and processing the process data;

wherein at least one of a plurality of the data processors is constituted by an array-type processor, this array-type processor including: a data path unit in which a plurality of processor elements, which individually execute data processing in accordance with instruction codes that have been individually set, and a plurality of switch elements, which individually switch-control the connection relations of the plurality of processor elements in accordance with instruction codes that have been individually set, are arranged in a matrix; and a state managing unit that successively switches contexts that are constituted by the instruction codes of the data path unit in accordance with the computer programs and the event data;

at least a portion of process data that have been processed by the other data processors is transmitted to the data path unit of the array-type processor; and at least a portion of process data that have been processed at the data path unit of the array-type processor is transmitted to the other data processors, and at least a portion of event data that are generated by the data path unit in accordance with data processing is transmitted to the other data processors.

The second data processing system of the present invention:

is a data processing system in which a plurality of data processors are connected in parallel, these data processors performing processing, in accordance with computer programs that have been set beforehand and event data that are received as input, of process data that have been received as input; this data processing system distributing said process data among this plurality of data processors and processing said process data;

wherein at least one of a plurality of data processors is constituted by an array-type processor, this array-type processor including: a data path unit in which a plurality of processor elements, which individually execute data processing in accordance with instruction codes that have been individually set, and a plurality of switch elements, which individually switch-control the connection relations of the plurality of processor elements in accordance with instruction codes that have been individually set, are arranged in a matrix; and a state managing unit that successively switches contexts that are constituted by the instruction codes of the data path unit in accordance with the computer programs and the event data;

at least a portion of process data that have been processed by the other data processors is transmitted to the data path unit of the array-type processor, and at least a portion of the event data that have been issued by the other data processors in accordance with the data processing is transmitted to the state managing unit; and

at least a portion of process data that have been processed at the data path unit of the array-type processor is transmitted to other data processors.

The third data processing system of the present invention:

is a data processing system in which a plurality of data processors are connected in parallel, these data processors performing processing, in accordance with computer program that has been set beforehand and event data that are received as input, of process data that have been received as input; this data processing system distributing the process data among this plurality of data processors and processing the process data;

wherein at least one of a plurality of data processors is constituted by an array-type processor, this array-type processor including: a data path unit in which a plurality of processor elements, which individually execute data processing in accordance with instruction codes that have been individually set, and a plurality of switch elements, which individually switch-control the connection relations of the plurality of processor elements in accordance with instruction codes that have been individually set, are arranged in a matrix; and a state managing unit that successively switches contexts that are constituted by the instruction codes of the data path unit in accordance with the computer programs and the event data;

at least a portion of process data that have been processed by the other data processors is transmitted to the data path unit of the array-type processor, and at least a portion of event data that have been issued by other data processors in accordance with data processing is transmitted to the state managing unit; and

at least a portion of process data that have been processed at the data path unit of the array-type processor is transmitted to the other data processors, and at least a portion of event data that have been generated by the data path unit in accordance with data processing is transmitted to the other data processors.

In any one of the first to third data processing systems of the above-described present invention, the mutual transmission of process data among the array-type processor and other data processors and the mutual transmission of event data that accord with this data processing enable the array-type processor and the other data processors to effectively cooperate and share in data processing.

In addition, in any one of the first to third data processing systems of the above-described present invention, the array-type processor may include a synchronization control circuit that executes at least one of: storing, by means of the state managing unit, event data that are read by the other data processors, and storing, by means of other data processors, event data that are read by the state managing unit. In this case, the mutual transmission of event data among the array-type processor and the other data processors can be reliably implemented by means of a simple construction.

In addition, in any one of the data processing systems of the above-described invention, the array-type processor may include data memory for temporarily storing various data in a freely updateable state, and this data memory may be shared by the array-type processor and the other data processors.

Another data processing system of the present invention:

is a data processing system that distributes process data that have been received as input among a plurality of data processors that are connected in parallel and processes the process data;

wherein at least one of a plurality of data processors is constituted by an array-type processor, this array-type processor including: a data path unit in which a plurality of processor elements, which individually execute data processing in accordance with instruction codes that have been individually set, and a plurality of switch elements, which individually switch-control the connection relations of the plurality of processor elements in accordance with instruction codes that have been individually set, are arranged in a matrix; a state managing unit that successively switches contexts that are constituted by the instruction codes of the data path unit in accordance with the computer program; and a data memory for temporarily storing various data in a state that allows free updating; and this data memory is shared by the array-type processor and the other data processors.

In the data processing system of the present invention as described above, the data memory of the array-type processor can also be shared by the other data processors, and the data memory of the array-type processor can therefore be effectively used as the data processing system, thereby preventing an increase in the circuit scale and improving the efficiency of use of the hardware.

Further, in the data processing system of the present invention as described above, the array-type processor may include an exclusive control circuit for granting exclusive use of the data memory to one of the array-type processor itself and the other data processors. This case can eliminate competition for the use of the data memory that is shared by the array-type processor and the other data processors.

In addition, in the data processing system of the present invention as described above, the data memory may be constituted by a plurality of memory units that are distributed in the data path unit, and the array-type processor may include a virtual recognition means for causing the other data processors to recognize this plurality of memory units as a single data memory. In this case, the plurality of memory units of the array-type processor can be used by the other data processors as a single data memory.

Further, in at least a portion of the memory units in the data processing system of the present invention as described above, access ports for accepting data reading/writing and storage areas for each item of address data may each be constituted by a plurality of multiport memories; and data reading/writing by the array-type processor and by the other data processors may be accepted simultaneously at access ports and storage areas that differ from each other. In this case, the same data memory can be used at the same time by the array-type processor and other data processors.

Further, in the above-described data processing system of the present invention, at least a portion of the plurality of memory units may be incorporated in at least a portion of the plurality of processor elements; and when a portion of the plurality of the processor elements of the array-type processor are using memory units, the other data processors may use memory units that are not being used in the remaining portion of processor elements. In this case, the array-type processor and other data processors can both use memory units at the same time.

In addition, in the above-described data processing system of the present invention, at least a portion of the plurality of processor elements may include register files for temporarily holding process data, and at least a portion of the plurality of memory units may be constituted by these register files. In this case, register files that are indispensable for the plurality of processor elements of the array-type processor can be used as data memory by other data processors.

In addition, in the above-described data processing system of the present invention, at least a portion of the plurality of processor elements may include instruction memories for temporarily holding instruction codes in a freely updateable state, and at least a portion of the plurality of memory units may be constituted by the instruction memories. In this case, hardware that is indispensable to the array-type processor can be used as data memory by other data processors.

In addition, in the above-described data processing system of the present invention, the array-type processor may include data buses that transmit process data of the plurality of processor elements and that are switch-controlled by means of the plurality of switch elements; and at least a portion of the plurality of memory units may be connected to these data buses in parallel with the processor elements. In this case, memory units that can be used for holding the process data of the processor elements in the array-type processor can also be used as data memory by other data processors.

In addition, in the above-described data processing system of the present invention, at least a portion of the plurality of processor elements may include instruction memories for temporarily holding instruction codes in a freely updateable state; the array-type processor may separately include: data buses that are switch-controlled by means of the plurality of switch elements and that transmit the process data of the plurality of processor elements, and command buses that transmit instruction codes that have been received as input to the plurality of processor elements; and

read/write data of the memory units that are used by the other data processors may be transmitted by the command buses. In this case, other data processors can use memory units by means of command buses that are not being used while the array-type processor is processing data.

In addition, in the above-described data processing system of the present invention, the state managing unit may further include an instruction decoder for decoding address data of a large number of bits to a plurality of items of address data of a small number of bits that are necessary for data storage of instruction codes in the instruction memories; and the data processing system may further include: a small number of large-capacity buses for transmitting the address data of a large number of bits that have been received as input to the state managing unit; and a large number of small-capacity buses for transmitting the address data of a small number of bits from the state managing unit as far as the plurality of processor elements. In this case, the address data can be transmitted to a large number of processor elements by means of a small number of buses.

In addition, in the data processing system of the above-described invention, the array-type processor may separately include: an address generation circuit for issuing address data in accordance with data reading of data memory by the other data processors; and a data read circuit for outputting read data that have been read from the data memory by means of the address data that have been issued by this address generation circuit; wherein the address generation circuit and the data read circuit may be arranged distributed on both sides of the data path unit. In this case, the time that is required when other data processors use the data memory of the array-type processor can be made uniform.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a schematic block diagram showing the logical structure of the data processing system of an embodiment of the present invention.

FIGS. 2A and 2B are block diagrams showing the physical structure of, for example, the m/nb buses of an array-type processor.

FIG. 3 is a block diagram showing the physical structure of, for example, the command buses.

FIG. 4 is a schematic view showing the data that are communicated between the synchronization control circuit and memory access unit.

FIG. 5 is a block diagram showing the internal structure of a read multiplexer.

FIGS. 6A and 6B are time charts showing various types of data of the memory access unit when reading/writing data to the data memory.

FIG. 7 is a time chart showing various types of data of the memory controller when reading/writing data to the data memory.

FIG. 8 is a time chart showing various types of data of the read multiplexer when reading data from the data memory.

FIG. 9 is a block diagram showing the principal elements of a modification.

### DETAILED DESCRIPTION OF THE PREFERRED EMBODIMENTS

In the data processing system of the present invention, a plurality of data processors that are connected in parallel perform data processing of process data that have been received as input in accordance with a computer program that has been set beforehand and event data that have been received as input, the processing of the process data being distributed among this plurality of data processors.

In the data processing system of an embodiment of the present invention, at least one of the plurality of data processors is constituted by an array-type processor, and this array-type processor includes a data path unit and a state managing unit. In the data path unit, a plurality of processor elements and a plurality of switch elements are arranged in a matrix, the processor elements each executing data processing in accordance with instruction codes that have been individually set, and the switch elements switch-controlling each of the connection relations of the plurality of processor elements in accordance with instruction codes that have been individually set. The state managing unit successively switches contexts, which are constituted by the instruction codes of the data path unit, in accordance with the computer program and the event data.

At least a portion of the process data that have been processed by the other data processors is transmitted to the data path unit of the array-type processor, and further, at least a portion of the event data that have been issued by the other data processors in accordance with the data processing is transmitted to the state managing unit. In addition, at least a portion of process data that have been processed by the data path unit of the array-type processor is transmitted to other data processors, and further, at least a portion of event data that are generated by the data path unit in accordance with data processing is transmitted to the other data processors. In other words, the array-type processor and the other data processors not only transmit process data to each other, but also transmit event data to each other that correspond to the processing of these data.

As another embodiment, event data that are stored by the state managing unit in the synchronization control circuit of the array-type processor are read by the other data processors, and event data that are stored by the other data processors are read by the state managing unit, whereby the array-type processor and the other data processors communicate event data to each other by means of the state managing unit.

Further, as another embodiment, data memory that belongs to the array-type processor is also shared by the other data processors, whereby the data memory of the array-type processor is effectively used by the data processing system.

As another embodiment, an exclusive control circuit grants exclusive use of the data memory to one of the array-type processor and the other data processors, whereby the data memory that is shared by the array-type processor and the other data processors is exclusively used.

As another embodiment, the data memory is constituted by a plurality of memory units that are distributed in the data path unit, and the array-type processor includes a virtual recognition means that causes the other data processors to recognize this plurality of memory units as a single data memory, whereby the plurality of memory units of the array-type processor is used as a single data memory by other data processors.

As another embodiment, in at least a portion of the plurality of memory units, access ports for accepting data reading/writing and storage areas for each item of address data are each constituted by a plurality of multiport memories; and by simultaneously accepting data reading/writing by the array-type processor and the other data processors at mutually differing access ports and storage areas, the multiport data memories are used at the same time by the array-type processor and the other data processors.

As another embodiment, at least a portion of the plurality of memory units are incorporated in at least a portion of the plurality of processor elements, and when the array-type processor is using the memory units of a portion of the plurality of processor elements, the other data processors use the memory units that are not being used in the other processor elements. Thus, even though a portion of the plurality of memory units is being used by the array-type processor, the remaining portion is used by the other data processors.

As another embodiment, at least a portion of the plurality of processor elements have register files for temporarily holding process data, and by constituting at least a portion of the plurality of memory units by register files, register files that are necessary to the plurality of processor elements of the array-type processor are shared by the other data processors.

Further, as another embodiment, at least a portion of the processor elements have instruction memories for temporarily holding instruction codes in a state that allows free updating; and by constituting at least a portion of the plurality of memory units from instruction memories, the instruction memories that are necessary to the plurality of processor elements of the array-type processor are shared by the other data processors.

In addition, as another embodiment, the array-type processor includes data buses that are switch-controlled by the plurality of switch elements and on which process data of the plurality of processor elements are transmitted; and by connecting at least a portion of the plurality of memory units to these data buses in parallel with the processor elements, memory units that are used for holding process data of the processor elements in the array-type processor are shared by the other data processors.

As another embodiment, at least a portion of the plurality of processor elements include instruction memories for temporarily holding instruction codes in a freely updateable state; and the array-type processor separately includes: data buses that are switch-controlled by the plurality of switch elements and on which process data of the plurality of processor elements are transmitted; and command buses on which instruction codes that are received as input are transmitted as far as the plurality of processor elements. By transmitting read/write data of memory units that are used by the other data processors on the command buses, memory units are used in the other data processors by means of the command buses that are not being used when the array-type processor is processing data.

As another embodiment, address data of a large number of bits that are received as input are transmitted by a small number of large-capacity buses as far as the state managing unit, an instruction decoder of the state managing unit decodes the address data of a large number of bits to a plurality of items of address data of a small number of bits, the items of address data of a small number of bits are transmitted by a large number of small-capacity buses from the state managing unit to a plurality of processor elements, and the instruction memories of the plurality of processor elements store the data of the instruction codes in accordance with the address data, whereby address data are transmitted by a small number of buses to a large number of processor elements.

As another embodiment, the array-type processor separately includes: an address generation circuit for issuing address data of the shared data memory in accordance with the reading of data by the other data processors; and a data read circuit for outputting read data that have been read from the data memory by means of address data that have been issued at the address generation circuit; and by arranging the address generation circuit and the data read circuit distributed on both sides of the data path unit, the sum of the time for address data to arrive at the data memory of the data path unit and the time for read data of the data memory to arrive at the data read circuit is made uniform.

Each of the various means of the present invention may take various forms to realize its respective function, and for example, may take the form of dedicated hardware that exhibits a prescribed function, a data processor that is given a prescribed function by means of a computer program, a prescribed function that is realized inside a data processor by means of a computer program, or a combination of these forms. Further, each of the various means of the present invention need not each exist independently, and a particular means may exist as a portion of another means.

An information storage medium in the present invention may be hardware in which a computer program is stored in advance for causing a data processor to execute various types of processing, and for example, may be a ROM (Read-only Memory) or an HDD (Hard Disk Drive) that is fixed in a device that includes a data processor as one part, or may be a CD (Compact Disk)-ROM or an FD (Flexible Disk cartridge) that is loaded in a state allowing free exchange in a device that includes a data processor as one part.

A data processor in the present invention may be hardware that can read the data of a computer program and execute corresponding data processing, and for example, may be hardware that takes as its main unit an MPU that is in turn connected to various types of devices such as ROM, RAM (Random Access Memory), or an I/F (Interface) circuit.

Further, the event data in the present invention are constituted, for example, by data for causing a transition of the current state that is managed by the state managing unit when the data path unit or the other data processors transmit to the state managing unit of the array-type processor, or by data for reporting to the other data processors the current state that is managed by the state managing unit when the state managing unit of the array-type processor transmits to other data processors.

### CONSTRUCTION OF A WORKING EXAMPLE

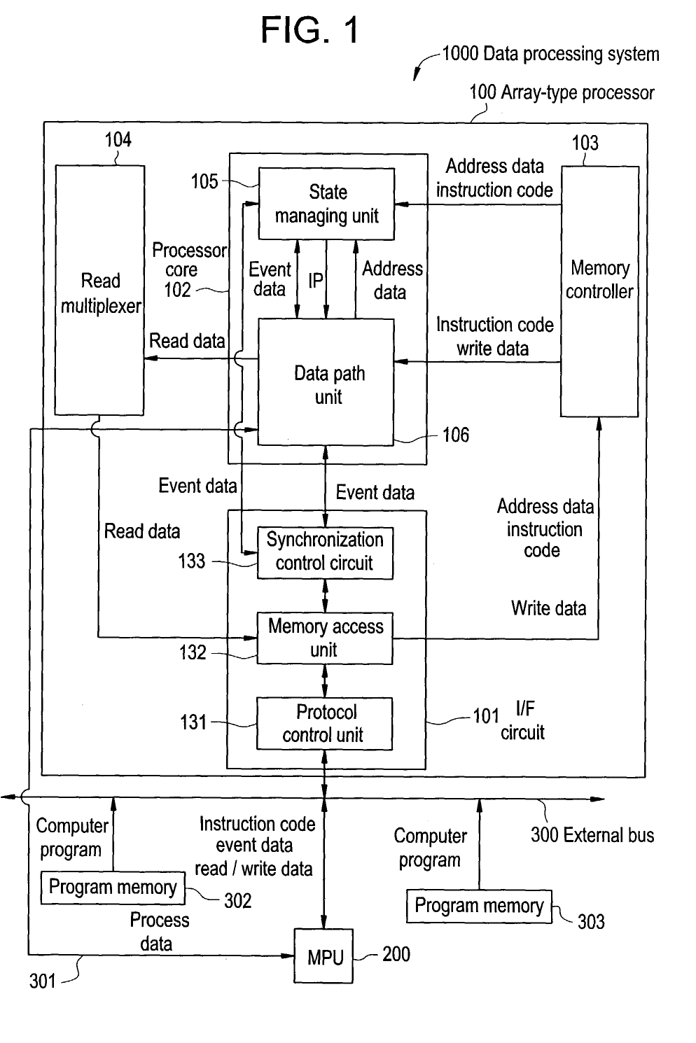

As shown in FIG. 1, data processing system 1000 of this working example includes one array-type processor 100 and one MPU 200 as the plurality of data processors, this array-type processor 100 and MPU 200 being connected to each other by external bus 300 and data line 301.

In data processing system 1000, program memory 302 that stores the computer program of array-type processor 100 and program memory 303 that stores the computer program of MPU 200 are provided exclusively for these uses, these program memories being connected to external bus 300.

Array-type processor 100 reads its own computer program from program memory 302, and executes data processing in accordance with this computer program. At this time, the process data that are received as input are processed and outputted at data path unit 106, and event data are generated at data path unit 106 in accordance with this data processing.

MPU 200 includes hardware such as an I/F circuit, a processor core, and an internal register (not shown in the figure), and as each of various functions, operation in accordance with the computer program that is stored in program memory 303 logically forms the various means such as the data input means, data processing means, data storage means, and data output means.

The data input means corresponds to the function by which the processor core recognizes the input data of the I/F circuit in accordance with a computer program, whereby process data and event data are received as input. The data processing means corresponds to the function by which the processor core executes data processing, whereby the process data that are received as input are subjected to data processing in accordance with the computer programs and event data.

The data storage means corresponds to the function by which the processor core stores process data in an internal register, whereby various types of data such as process data are temporarily stored. The data output means corresponds to the function by which the processor core controls the data output of the I/F circuit, whereby the event data and process data that have undergone processing are outputted.

However, MPU 200 of data processing system 1000 receives at least a portion of the process data and event data from array-type processor 100, issues new event data in accordance with at least a portion of the data processing, and outputs at least a portion of the process data and the newly issued event data to array-type processor 100. MPU 200 further temporarily stores each type of data in a data storage means as previously described, and MPU 200 causes array-type processor 100 to temporarily store at least a portion of these various types of data.

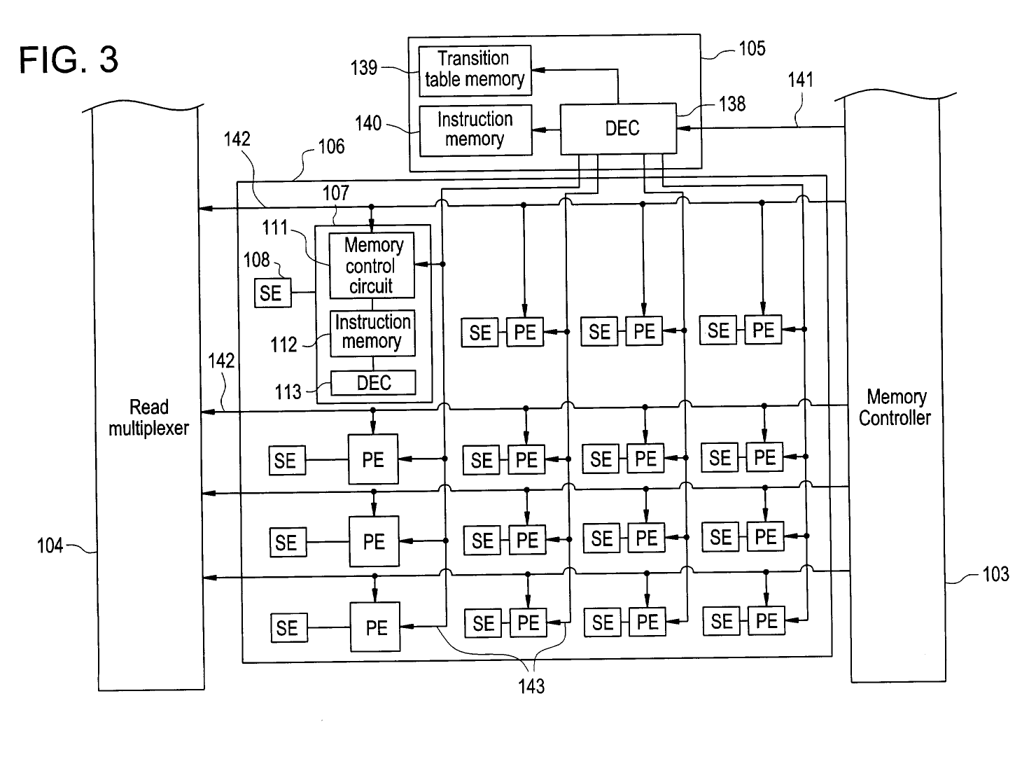

Array-type processor 100 includes components such as: I/F circuit 101; processor core 102; memory controller 103, which is the virtual recognition means and the address generation circuit; and read multiplexer 104, which is the data read circuit; and, as shown in FIG. 1 and FIG. 3, processor core 102 includes state managing unit 105 and data path unit 106.

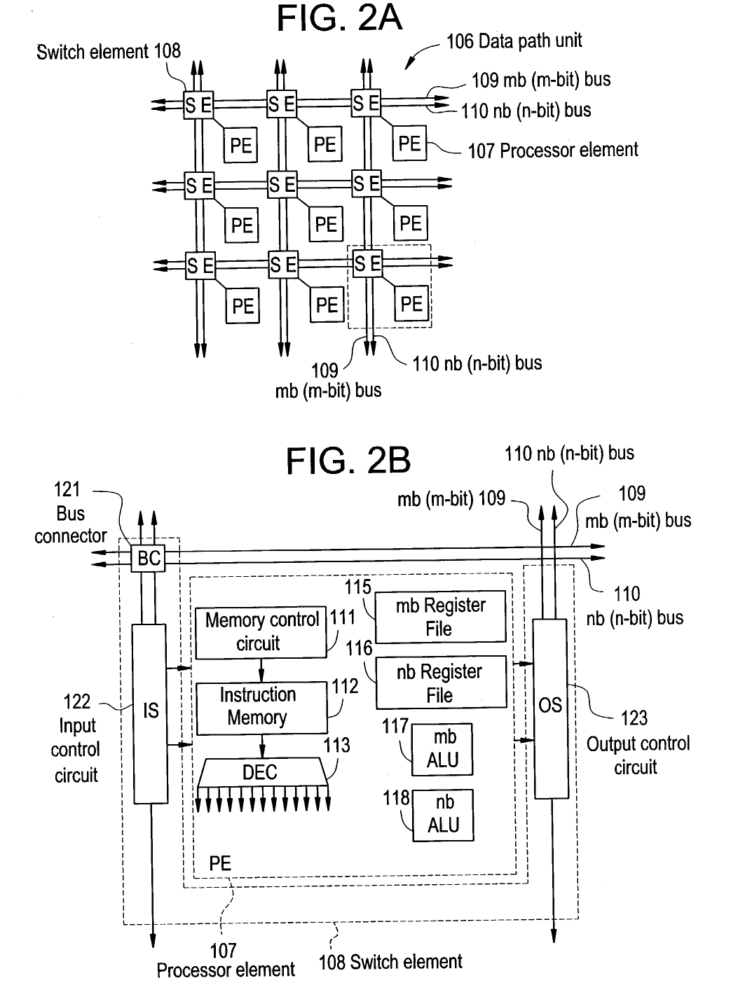

As shown in FIG. 2A and FIG. 3, data path unit 106 includes: a plurality of processor elements 107; a plurality of switch elements 108; a large number of mb (m-bit) buses 109, which are a portion of the data bus; a large number of nb (n-bit) buses 110, which are a portion of the data buses; the plurality of processor elements 107 and the plurality of switch elements 108 being arranged in a matrix with the large number of mb and nb buses 109 and 110 connecting the matrix together.

As shown in FIG. 2B, processor elements 107 include: memory control circuit 111; instruction memory 112, which is a memory unit and a portion of the data memory; instruction decoder 113; mb register file 115, which is memory unit and a portion of the data memory; nb register file 116, which is a memory, unit and a portion of the data memory; mb ALU (Arithmetic and Logical Unit) 117; nb ALU 118; internal variable connects (not shown in the figure); and switch element 108 includes components such as: bus connector 121; input control circuit 122, and output control circuit 123.

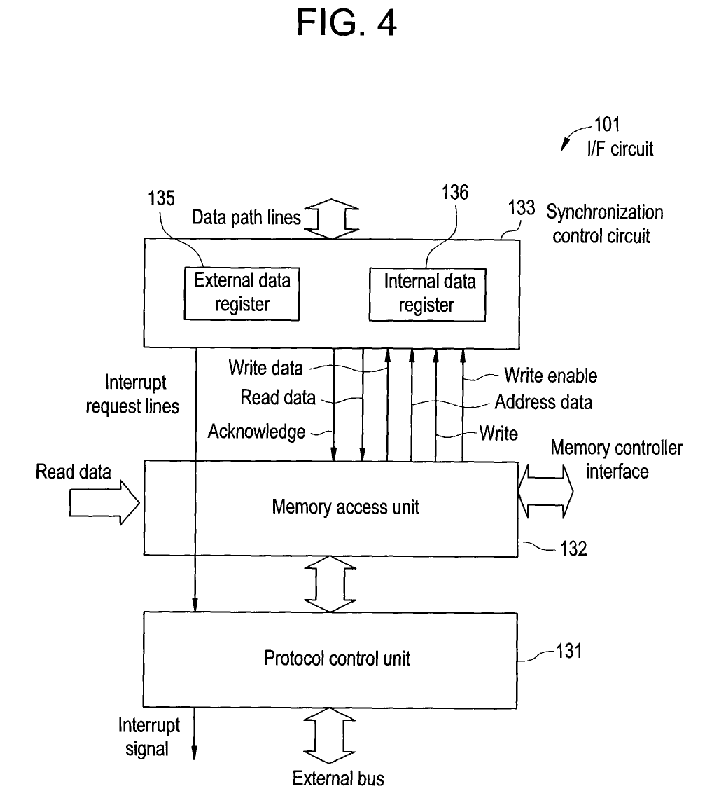

As shown in FIG. 1 and FIG. 4, I/F circuit 101 includes protocol control unit 131, memory access unit 132, and synchronization control circuit 133; protocol control unit 131 being connected to external bus 300 and memory access unit 132. This memory access unit 132 is connected to memory controller 103, read multiplexer 104, and synchronization control circuit 133; and synchronization control circuit 133 is connected to data path unit 106 of processor core 102.

Protocol control unit 131 is set to a bus protocol that is common to external bus 300 and both communicates various types of data to external bus 300 in accordance with this bus protocol and communicates various types of data to memory access unit 132 by a simpler method.

As shown in FIG. 1, this memory access unit 132 transmits the various types of data, which have been applied as input from MPU 200 to protocol control unit 131 by way of external bus 300, to memory controller 103, data path unit 106, and synchronization control circuit 133, and outputs the various types of data that have been transmitted from these components from protocol control unit 131 to MPU 200 by way of external bus 300.

As shown in FIG. 4, synchronization control circuit 133 includes external data register 135 and internal data register 136; temporarily holds event data, which have been applied as input from MPU 200 to protocol control unit 131 by way of external bus 300, in external data register 135; and temporarily holds event data, which have been written by means of state managing unit 105, in internal data register 136.

As shown in FIG. 1, event data that have been temporarily held by external data register 135 of synchronization control circuit 133 are read by state managing unit 106 by way of data path unit 106, and event data that have been temporarily held by internal data register 136 are read by MPU 200.

Memory controller 103 transmits the various types of data that are transmitted from memory access unit 132 of I/F circuit in the 101 to state managing unit 105 and data path unit 106 of processor core unit 102; and read multiplexer 104 transmits data that have been read from data path unit 106 to memory access unit 132.

To describe in greater detail, as shown in FIG. 3, state managing unit 105 includes instruction decoder 138, transition table memory 139, and instruction memory 140; instruction decoder 138 and memory controller 103 being connected by command bus 141, which is a large-capacity bus.

Processor elements 107 are arranged in, for example, four rows and four columns, and each row of the four rows of command buses 142 that are connected in parallel from memory controller 103 to read multiplexer 104 is connected to memory control circuits 111 of each of the four columns of processor elements 107.

Address buses 143, which are a small-capacity buses, for the four columns are connected to the single instruction decoder 138 of state managing unit 105, and each column of these address buses 143 is connected to the memory control circuits 111 of the four rows of processor elements 107. Command bus 141 is formed with a bus width of, for example, 20 bits, i.e., a large number of bits; and command buses 142 and address buses 143 are formed with a bus width of, for example, 8 bits, i.e., a small number of bits.

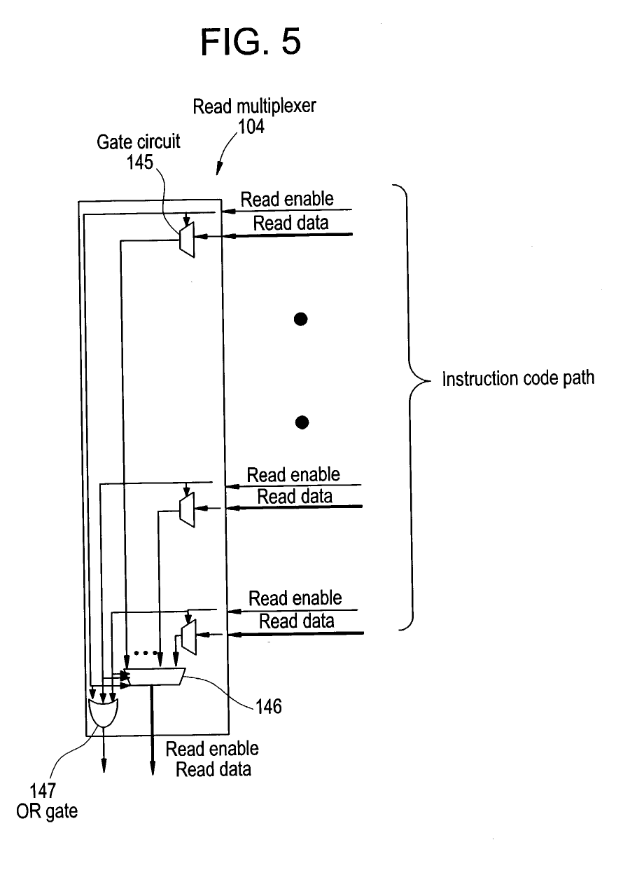

As shown in FIG. 5, read multiplexer 104 includes four gate circuits 145, one multiplexer 146, and one OR gate 147; and the four rows of command buses 142 each connect to a respective one of gate circuits 145 as well as to single OR gate 147. The four gate circuits 145 connected to single multiplexer 146 and this multiplexer 146, together with OR gate 147, are connected to memory access unit 132 of I/F circuit 101.

Although instruction memory 112 for temporarily holding instruction code and m/nb register files 115 and 116 for temporarily holding m/nb process data are formed for each of the plurality of processor elements 107, array-type processor 100 causes MPU 200 to recognize these as a single data memory.

Regarding the computer program of array-type processor 100 that is stored in program memory 302, the instruction code of the plurality of processor elements 107 and switch elements 108 that are arranged in a matrix in data path unit 106 is set as contexts that successively switch; and the instruction code of state managing unit 105 that switches these contexts with each operation cycle is set as operating states that successively undergo transition.

Thus, as shown in FIG. 3, the instruction code of state managing unit 105 itself as described above is stored as data in instruction memory 140, and the transition rules for causing successive transitions of the plurality of operating states are stored in transition table memory 139.

State managing unit 105 causes successive transitions of the operating states in accordance with the transition rules of transition table memory 139, and generates each of the instruction pointers of the plurality of processor elements 107 and the plurality of switch elements 108 in accordance with the instruction code of instruction memory 140.

As shown in FIG. 2B, switch element 108 shares the use of instruction memory 112 of adjacent processor element 107, and state managing unit 105 supplies the generated instruction pointers of the set of processor element 107 and switch element 108 to instruction memory 112 of the corresponding processor element 107.

Because the plurality of instruction codes of processor elements 107 and switch elements 108 are stored in this instruction memory 112, the instruction code of processor elements 107 and switch elements 108 is designated by the two instruction pointers that are supplied from state managing unit 105. Instruction decoder 113 decodes the instruction code that has been designated by the instruction pointers and controls the operation of components such as switch elements 108, internal variable lines, and m/nb ALU 117 and 118.

Because mb bus 109 transmits process data of “8 bits” which is mb, and nb bus 110 transmits process data of “1 bit” which is nb, switch elements 108 control the connection relations of the plurality of processor elements 107 realized by m/nb buses 109 and 110 in accordance with the operation control of instruction decoder 113.

To describe in more detail, the bus connectors 121 of switch elements 108 are linked in four directions by mb buses 109 and nb buses 110, and these switch elements 108 control the mutual connection relations of the plurality of mb buses 109 that are linked and the mutual connection relations of the plurality of nb buses 110 that are linked in this way.

Thus, in array-type processor 100, state managing unit 105 successively switches the context of data path unit 106 with each operation cycle in accordance with the computer program that has been set in program memory 302, and with each of these stages, the plurality of processor elements 107 operate in parallel, each at data processing that is freely and independently set.

As shown in FIG. 2B, input control circuit 122 controls the connection relations of data input from mb bus 109 to mb register file 115 and mb ALU 117 and the connection relation of data input from nb bus 110 to nb register file 116 and nb ALU 118.

Output control circuit 123 controls the connection relations of data output from mb register file 115 and mb ALU 117 to mb bus 109 and the connection relations of data output from nb register file 116 and nb ALU 118 to nb bus 110.

The internal variable lines of processor elements 107 control the connection relations of mb register file 115 and mb ALU 117 inside processor elements 107 and the connection relations of nb register file 116 and nb ALU 118 in accordance with the operation control of instruction decoder 113.

In accordance with the connection relations that are controlled by internal variable lines, mb register file 115 temporarily holds mb process data that are received as input from, for example, mb bus 109 and outputs to, for example, mb ALU 117. In accordance with the connection relations that are controlled by internal variable lines, nb register file 116 temporarily holds nb process data that are received as input from, for example, nb bus 110 and outputs to, for example, nb ALU 118.

Data processing of the process data of mb is executed by mb ALU 117 in accordance with the operation control of instruction decoder 113, and nb ALU 118 executes data processing of the process data of nb in accordance with the operation control of instruction decoder 113, whereby data processing of m/nb is appropriately executed in accordance with the number of bits of process data.

The processing results in this data path unit 106 are fed back as event data to state managing unit 105 as necessary, and using this event data that are received as input, state managing unit 105 both brings about transitions from one operating state to the next operating state and switches the context of data path unit 106 to the next context.

### OPERATION OF THE WORKING EXAMPLE

In data processing system 1000 of the present working example in the above-described construction, MPU 200 functions as the main processor and array-type processor 100 functions as a coprocessor to link the data processing of array-type processor 100 and MPU 200.

In this case, array-type processor 100 and MPU 200 each read their own computer programs from program memories 302 and 303, execute the corresponding processing operations, process the process data that are received as input from data line 301, and output the process data that have undergone processing to data line 301. However, because the construction of array-type processor 100 differs from that of a typical MPU 200, its processing operations are unique.

To state in more detail, the computer program of array-type processor 100 is set as contexts in which the instruction codes of the plurality of processor elements 107 and switch elements 108 change successively, as previously described, and the instruction codes of state managing unit 105 that switches this context with each operation cycle are set as operating states that undergo successive transitions.

In array-type processor 100 that operates in accordance with this type of computer program, state managing unit 105 not only causes successive transitions of the operating state, but also successively switches the contexts of data path unit 106 with each operation cycle. Thus, with each operation cycle, the plurality of processor elements 107 each operate in parallel at data processing that is freely set independently and the connection relations of this plurality of processor elements 107 are switch-controlled by the plurality of switch elements 108.

At this time, processing results in data path unit 106 are fed back as necessary to state managing unit 105 as event data, and this state managing unit 105, in accordance with the event data that have been received as input, both causes transitions from one operating state to the next operating state and changes the context of data path unit 106 to the next context.

The foregoing explanation assumes a case in which the instruction codes of instruction memories 140 and 112 of state managing unit 105 and processor elements 107 have been stored in advance. However, the instruction code of this type of instruction memory 112 can be updated, and this [updating] can be executed by MPU 200 in array-type processor 100 or can be executed by array-type processor 100 alone.

More specifically, the instruction codes of state managing unit 105, processor elements 107, and switch elements 108 can be read from program memory 302 by MPU 200 or processor elements 107 as necessary, applied as input from external bus 300 to I/F circuit 101, and transmitted from memory access unit 132 of I/F circuit 101 to memory controller 103.

The instruction code of state managing unit 105 is transmitted as data on command bus 141 from this memory controller 103 to state managing unit 105, and the pair of instruction codes of the processor element 107 and the adjacent switch element 108 are transmitted from memory controller 103 to processor element 107 by command bus 142.

At state managing unit 105, the instruction code that has been transmitted is then decoded at instruction decoder 138 and stored in instruction memory 140, and the transition rules of the plurality of operating states are stored in transition table memory 139. Because the plurality of instruction codes that correspond to the plurality of operating states are stored in instruction memory 140, this plurality of address data is also transmitted from memory controller 103 to state managing unit 105.

Address data of instruction memory 140 in which the instruction code is stored are also encoded and set in the instruction code that is transmitted by command bus 141 to state managing unit 105, and these data are therefore also decoded by instruction decoder 138 and transmitted to one column of processor elements 107 by one address bus 143 that has been selected from the four columns of address buses 143.

At the same time, when instruction code is stored in instruction memory 112 of processor element 107, one of the four rows of command buses 142 is selected by memory controller 103 and the instruction code then transmitted. Since instruction code and address data are thus transmitted to a single processor element 107, the instruction code is stored in a single address space of instruction memory 112 that corresponds to the address data

Array-type processor 100 is able to execute the previously described processing operations when the transition rules of the plurality of operating states and the plurality of instruction codes have been stored in state managing unit 105 and plurality of contexts have been stored in data path unit 106 as described in the foregoing explanation.

When MPU 200 has processed process data that have been received as input in accordance with its own computer program in data processing system 1000, at least a portion of the process data is transmitted from data line 301 to data path unit 106 of array-type processor 100 and at least a portion of the event data that are issued in accordance with this data processing is transmitted from external bus 300 to state managing unit 105.

In addition, when array-type processor 100 executes data processing in accordance with a computer program, at least a portion of the process data that have been processed at data path unit 106 is transmitted from data line 301 to MPU 200, and at least a portion of the event data that have been generated in accordance with the data processing of data path unit 106 is transmitted from external bus 300 to MPU 200.

This sharing of the process data by array-type processor 100 and MPU 200 enables a division of a series of data processing between array-type processor 100 and MPU 200. At the same time, the communication of event data between array-type processor 100 and MPU 200 enables synchronization of the data processing that is being executed independently.

The synchronization here described refers to the ability of array-type processor 100 and MPU 200 to communicate process data at prescribed timings, and does not refer to the matching of the speed or stage of data processing that is executed independently by array-type processor 100 and MPU 200.

A plurality of methods are implemented in data processing system 1000 as a means for communicating event data between array-type processor 100 and MPU 200 as described above. As an example, synchronization control circuit 133 has the function of issuing control signals that are to become event data directly to state managing unit 105 as shown in FIG. 1, and the address data of synchronization control circuit 133 that issues these event data are allocated to external bus 300.

When MPU 200 communicates event data to array-type processor 100, MPU 200 stores prescribed data from external bus 300 to a prescribed address of an internal register (not shown in the figure) of synchronization control circuit 133, and in response, control signals that are to become event data are issued from synchronization control circuit 133 to state managing unit 105.

Signals such as binary run signals for controlling the execution of operation and the halt of operation of array-type processor 100 and a binary reset signal for initializing state managing unit 105 are prepared as these control signals. For example, when MPU 200 updates the instruction code of array-type processor 100, the transmission by MPU 200 of event data to synchronization control circuit 133 changes the binary “run” signal from “operation execution” to “operation halt” and after updating the instruction code of array-type processor 100 that has been thus halted, the “run” signal is changed to “operation execution”.

In this case, MPU 200 can cause array-type processor 100 to execute a series of data processing of a greater number of instruction codes than the number that can be temporarily held in instruction memories 112 and 140 and can change the data processing that is being executed to a different data processing at a desired timing.

In addition, when the event data that are communicated by MPU 200 to array-type processor 100 are stored from external bus 300 to external data register 135 of synchronization control circuit 133, these event data are, for example, transmitted to state managing unit 105 by the processing operation of data path unit 106.

Here, it is possible to transmit event data by a connection path of data path unit 106 that is being dynamically switch-controlled by state managing unit 105 as well as to transmit event data by a connection path that is statically secured in data path unit 106 by state managing unit 105. In addition, the event data that have been stored in external data register 135 of synchronization control circuit 133 can also be transmitted as far as state managing unit 105 by a dedicated signal line (not shown in the figure), as with the previously described control signals.

However, even if event data are stored from the outside to external data register 135 of synchronization control circuit 133, [the storage of this data] cannot be recognized by state managing unit 105 and data path unit 106. When event data are stored from the outside to external data register 135, the request signal that communicates this fact is transmitted from synchronization control circuit 133 to data path unit 106 and state managing unit 105 by a dedicated signal line.

Then, when event data are read from external data register 135 to, for example, state managing unit 105 in accordance with this request signal, an “acknowledge” signal for reporting both the completion of reading and a request for initializing the request signal is transmitted from state managing unit 105 to synchronization control circuit 133 by way of a dedicated signal line.

When array-type processor 100 communicates event data to MPU 200, the event data are stored in internal data register 136 of synchronization control circuit 133, whereupon an interrupt signal is issued from synchronization control circuit 133 to MPU 200 as event data when the binary interrupt setting of synchronization control circuit 133 that is initially set according to the user's wishes is “enable” or, when the interrupt setting is “prohibit” MPU 200 reads the event data of synchronization control circuit 133 by, for example, a polling operation.

When the interrupt setting is “enable” as described above and an interrupt signal is issued from array-type processor 100 to MPU 200, at least an interrupt handler and an interrupt signal are placed in correspondence and set in the computer program in MPU 200, and at least the event data and the interrupt signal are placed in correspondence and set in the computer program in array-type processor 100.

When the interrupt handler is activated by the interrupt signal, MPU 200 searches for the cause of the interruption, thereby detects synchronization control circuit 133 of array-type processor 100, reads the event data that are the cause of the interruption, and executes the interrupt processing in accordance with these event data.

In this type of event data, the operating state of state managing unit 105 of array-type processor 100 can be set in data and communicated to MPU 200, and MPU 200 can therefore execute interruption processing that is synchronized to the operating state of array-type processor 100

In array-type processor 100, moreover, synchronization control circuit 133 also issues an interrupt signal as event data as a result of the alteration of the above-described “run” signal from “operation execution” to “operation halt” by state managing unit 105, and in this case MPU 200 can execute various operations in array-type processor 100, which has halted operations due to the interrupt processing, and can cause array-type processor 100 to begin operating at, for example, the timing of completion of the interrupt process.

Further, MPU 200 can also, for example, execute an alteration of the “run” signal or reply with a response signal as event data to array-type processor 100 upon completion of reading the event data or at a prescribed timing of the interrupt processing, whereby array-type processor 100 can again begin data processing in synchronization with MPU 200.

In addition, when MPU 200 is to read event data that have been stored in synchronization control circuit 133 when the interrupt setting of array-type processor 100 is “prohibit”, MPU 200 can read event data from array-type processor 100 by means of a periodic polling operation, or can read event data from array-type processor 100 at desired timings by means of a specific processing operation. When MPU 200 reads event data from array-type processor 100 by means of a specific processing operation as well, MPU 200 repeats the polling operation until it has read the event data from array-type processor 100. If MPU 200 executes this polling operation for reading event data at an appropriate timing, operation delay is prevented; but if MPU 200 reads event data by interrupt processing, MPU 200 can recognize the state of array-type processor 100 immediately.

As previously described, although each of the plurality of processor elements 107 of array-type processor 100 in data processing system 1000 includes instruction memory 112 and m/nb register files 115 and 116, MPU 200 is caused to recognize these as a single data memory.

More specifically, instruction memories 112 and m/nb register files 115 and 116 of the plurality of processor elements 107 are defined as the memory space of a single data memory in memory controller 103 of array-type processor 100.

As a result, MPU 200 recognizes the large number of instruction memories 112 and m/nb register files 115 and 116 that are distributed in array-type processor 100 as a single data memory and can therefore execute data reading and writing without any need for complex data management.

In m/nb register files 115 and 116 and instruction memories 112 that serve as data memory in data processing system 1000, the access ports for accepting data reading and writing and storage areas for each item of address data are each constituted by a plurality of multiport memories, and data reading and writing by array-type processor 100 and MPU 200 can therefore be executed at the same time at separate access ports and storage areas.

In array-type processor 100, moreover, instruction codes that correspond to a plurality of contexts are stored in instruction memories 112 from command buses 142 as previously described, and when a series of data processing is being executed by means of the arithmetic processing of processor elements 107 and the connection control of switch elements 108, m/nb buses 109 and 110 are almost always in use for transmitting the m/nb of processing data, while command buses 142 are in use only briefly for transmitting instruction code as far as instruction memories 112.

However, if MPU 200 transmits the read/write data by command buses 142 when executing data reading or writing to the data memory of array-type processor 100 in data processing system 1000, the already existing hardware can be more effectively used and the need to add dedicated hardware can be eliminated.

The processing operations for a case in which MPU 200 uses the data memory of array-type processor 100 as described above are next explained in order. First, when MPU 200 is to execute data writing to the data memory of array-type processor 100, these write data are transmitted to memory access unit 132 from external bus 300.

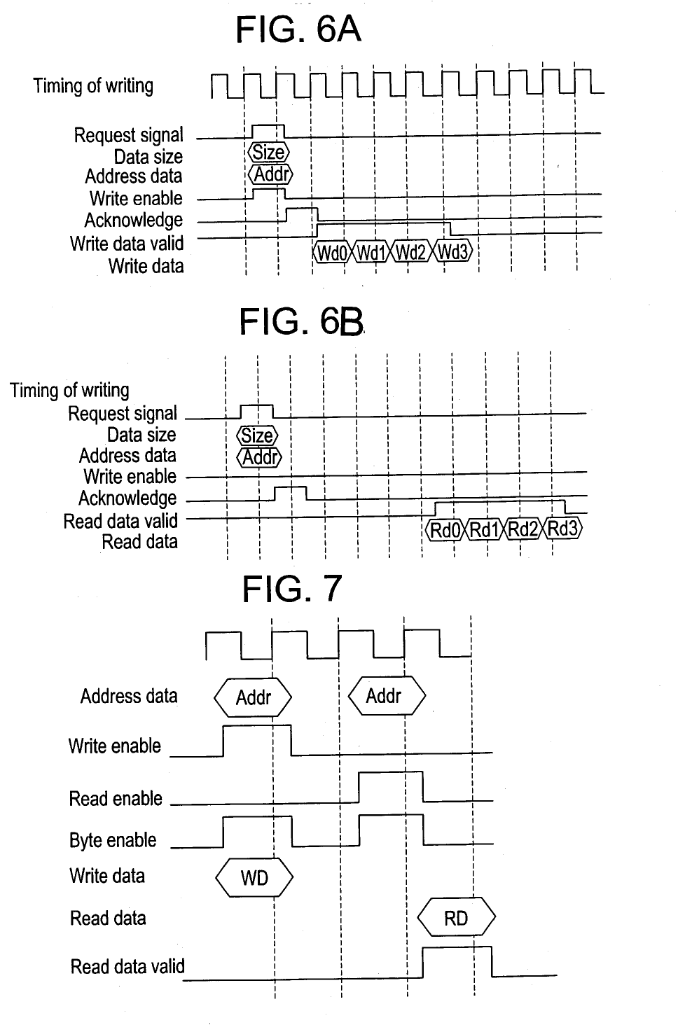

At this time, the address data of the write data are also transmitted from MPU 200 to memory access unit 132, and as a result, the request signal for data writing, the size and address data of the write data, and a “write enable” signal are transmitted from this memory access unit 132 to memory controller 103 as shown in FIG. 6A.

Memory controller 103 next replies to memory access unit 132 with an “acknowledge” signal when writing of these data is possible; and memory access unit 132, having received this “acknowledge” signal, sends the write data together with a “valid” signal to memory controller 103.

Memory controller 103 transmits address data of a large number of bits of, for example, “20 bits” together with a “write enable” signal and a “byte enable” signal to state managing unit 105 by means of command bus 141 as shown in FIG. 7; whereupon these address data are decoded at instruction decoder 138 of state managing unit 105 to address data of a small number of bits of, for example, “8 bits” and transmitted to one of the plurality of address buses 143 together with a “write enable” signal.

At the same time, memory controller 103 divides the write data of a large number of bits that has been received from memory access unit 132 by the prescribed plurality of bits constituted by, for example, “8 bits”, and these write data are then transmitted to one of the plurality of command buses 142 together with the “byte enable” signal.

As described in the foregoing explanation, one processor element 107 is selected by both transmitting the “write enable” signal on one address bus 143 and transmitting the “byte enable” signal on one command bus 142, and the write data are written to instruction memory 112 of this processor element 107 in accordance with the address data.

On the other hand, when MPU 200 is to execute data reading from the data memory of array-type processor 100, the request signal of the data read and the size and address data of the read data are transmitted to memory controller 103 from memory access unit 132, as shown in FIG. 6B.

At this time, the fact that a “write enable” signal is not transmitted causes memory controller 103 to recognize that this is a case of data reading and not data writing, and when this data read is possible, responds with an “acknowledge” signal to memory access unit 132, whereby memory access unit 132, having received this “acknowledge” signal, transmits a “valid” signal to memory controller 103.

As shown in FIG. 7, this memory controller 103 transmits address data of a large number of bits of, for example “20 bits” to state managing unit 105 by means of command bus 141 together with a “read enable” signal and “byte enable” signal, whereby instruction decoder 138 of state managing unit 105 decodes this address data of a large number of bits to address data of a small number of bits of, for example “8 bits”, and transmits [the address data] together with the “read enable” signal to one of the address buses 143.

At the same time, memory controller 103 transmits the “byte enable” signal, the “valid” signal, and read data of a prescribed number of bits such as “8 bits” to one of the plurality of command buses 142, whereby the read data that accord with the address data are read from the instruction memory 112 of the single processor element 107 that has been selected by the “read enable” signal and “byte enable” signal.

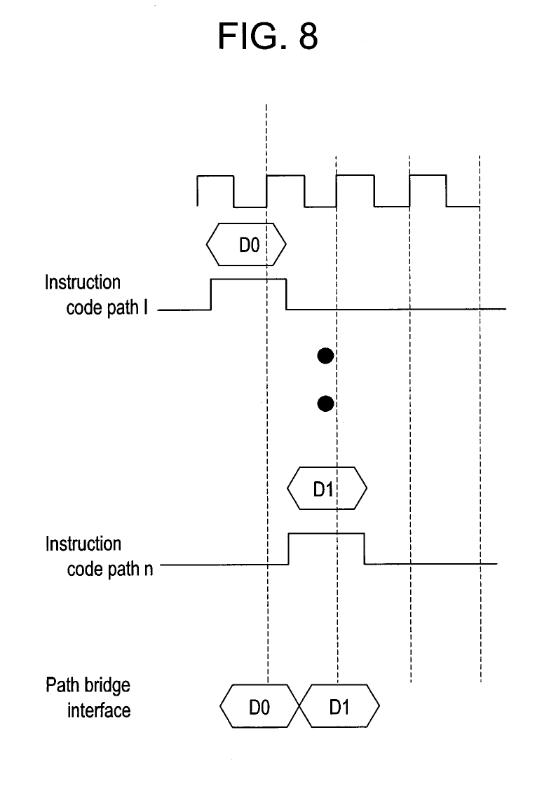

As shown in FIG. 5, these read data are transmitted together with the “read enable” signal by way of command bus 142 as far as read multiplexer 104; and as shown in FIG. 8, these read data and “read enable” signal are transmitted from this read multiplexer 104 as necessary to memory access unit 132 as a single item of read data of a large number of bits, whereby, as shown in FIG. 6B, this memory access unit 132 transmits the read data together with the “valid” signal from external bus 300 to MPU 200.

### EFFECT OF THE PRESENT WORKING EXAMPLE

As described in the foregoing explanation, array-type processor 100 and MPU 200 in data processing system 1000 of the present working example communicate process data to each other and also communicate event data that correspond to this data processing to each other, whereby array-type processor 100 and MPU 200 can effectively link operations and divide data processing. In particular, the use of synchronization control circuit 133 for the mutual communication of event data by array-type processor 100 and MPU 200 allow array-type processor 100 and MPU 200 to reliably link data processing by means of a simple construction.

In data processing system 1000 of the present working example, MPU 200 also shares the data memory that is constituted by the large number of instruction memories 112 and m/nb register files 115 and 116 of array-type processor 100 as described above, whereby the data memory can be efficiently utilized.

Nevertheless, memory controller 103 causes MPU 200 to recognize the large number of instruction memories 112 and m/nb register files 115 and 116 that are distributed in array-type processor 100 as a single data memory, and MPU 200 is therefore allowed to efficiently use the data memory of array-type processor 100 without need for complex data management.

In addition, m/nb register files 115 and 116 and instruction memories 112 that MPU 200 shares as a data memory are also indispensable hardware for array-type processor 100, whereby data memory that is shared by MPU 200 need not be added to array-type processor 100 in data processing system 1000.

Further, the read/write data of memory units that are used by MPU 200 are transmitted on command buses 142 that are provided for transmitting the instruction code that is received as input as far as instruction memories 112 of the plurality of processor elements 107, and MPU 200 can therefore be allowed to use memory units by means of command buses 142 that are not used during data processing in array-type processor 100.

Still further, array-type processor 100 and MPU 200 simultaneously execute data reading/writing to m/nb register files 115 and 116, which are constituted from multiport memory, at different access ports and storage areas, whereby array-type processor 100 and MPU 200 can use the same data memory at the same time.

In addition, address data of a large number of bits that are transmitted by a single large-capacity command bus 141 are decoded at instruction decoder 138 of state managing unit 105 to a plurality of items of address data of a small number of bits, following which the address data are transmitted to the plurality of processor elements 107 by a large number of small-capacity address buses 143. As a result, array-type processor 100 can transmit address data to a large number of processor elements 107 by way of a small number of buses 141 and 143, and the circuit scale can be correspondingly reduced.

In addition, memory controller 103, which issues address data of the data memory that is shared in data reading by MPU 200, and read multiplexer 104, which outputs read data that have been read from the data memory by means of address data that have been issued by this memory controller 103, are arranged distributed on both sides of data path unit 106.

As a result, the sum of the time required for address data to reach the data memory of data path unit 106 and the time required for read data to reach read multiplexer 104 from data memory is uniform, whereby the required time when MPU 200 uses the data memory of array-type processor 100 can be kept uniform.

### A MODIFICATION OF THE PRESENT WORKING EXAMPLE

The present invention is not limited to the above-described working example, and various modifications may be made within the range that does not depart from the gist of the present invention. As an example, in the present working example a case was described in which MPU 200 was allowed to share, as a data memory, instruction memories 112 and m/nb register files 115 and 116 that are incorporated in each of the large number of processor elements 107 of array-type processor 100, but it is also possible for MPU 200 to use, as data memory, only one of these forms of memory. In addition, instruction memory 140 also exists in state managing unit 105 of array-type processor 100 of the present working example, and MPU 200 can be allowed to use this instruction memory 140 as a portion of the data memory.

In addition, memory units (not shown in the figure) that do not include m/nb ALU 117 and 118 may also be substituted for a portion of the large number of processor elements 107, and MPU 200 may be allowed to share these memory units as at least a portion of the data memory. In this case as well, the read/write data of the memory units can be transmitted by command buses 142 instead of by a dedicated bus, whereby already existing hardware can be efficiently used and increase in the circuit scale can be prevented.

As data processing system 1000 in this working example, a configuration has been described in which a single array-type processor 100 and a single MPU 200 are connected. However, this MPU 200 may be replaced by an ASIC (Application Specific Integrated Circuit), a FPGA (Field Programmable Gate Array), a VLIW (Very Long Instruction Word) processor, or an array-type processor.

A data processing system may be formed by connecting two or more data processors, and as these data processors, two or more types of processors may be mixed. In the present working example, moreover, a construction was described in which array-type processor 100 and MPU 200 are directly connected, but this connection may also be realized by way of various devices.

In the present working example, a case was described in which instruction memories 112 and m/nb register files 115 and 116 that serve as the data memory are constituted from multiport memories and in which data writing by means of array-type processor 100 and MPU 200 can be executed at the same time, but this type of data memory may also be formed from single-port memories.

As an example, when instruction memories 112 are constituted by single-port memories, data writing by array-type processor 100 and MPU 200 cannot be executed at the same time. However, array-type processor 100 includes a large number of processor elements 107 that are arranged in a matrix, and not all instruction memories 112 of processor elements 107 will be in use all of the time.

When a portion of the plurality of processor elements 107 in array-type processor 100 are using instruction memories 112 in data processing system 1000, MPU 200 can use instruction memories 112 that are not being used at other processor elements 107.

However, as previously described, when MPU 200 uses the data memory of array-type processor 100, competition for memory use between array-type processor 100 and MPU 200 must be resolved. In data processing system 1000 of the present working example, however, array-type processor 100 and MPU 200 communicate event data to each other as previously described, thereby enabling each to recognize the state of the other and to cooperate in data processing, whereby competition can be resolved and shared use of the memory can be realized.

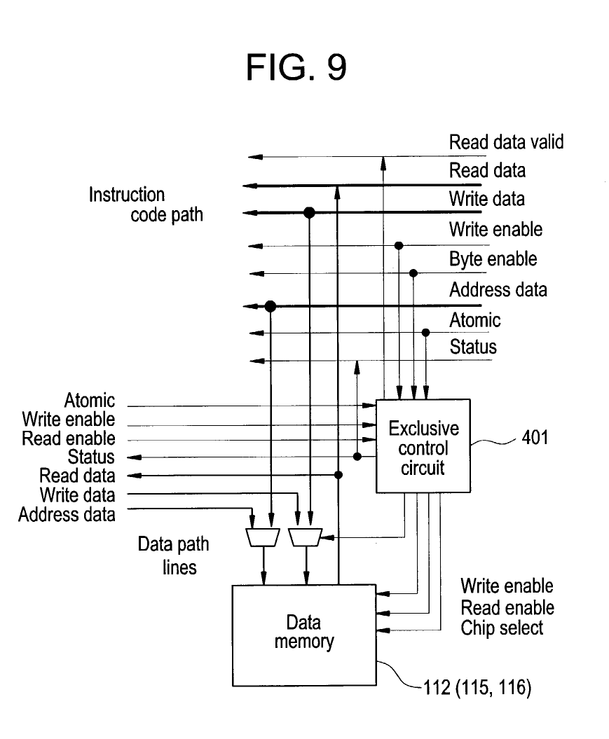

In the present working example, an example has been described in which array-type processor 100 and MPU 200 communicate event data to each other by means of dedicated synchronization control circuit 133 and in which the data memory constituted by instruction memories 112 and m/nb register files 115 and 116 is exclusively used. However, exclusive use can also be realized by connecting exclusive control circuit 401 to the components of data memory such as instruction memories 112 and m/nb register files 115 and 116, as shown in FIG. 9.

Regarding this method, it is first assumed that array-type processor 100 and MPU 200 share data memory without using either synchronization control circuit 133 or exclusive control circuit 401, and when executing a process for establishing synchronization between array-type processor 100 and MPU 200, the numerical value of a specific area in the data memory is incremented by “1”, and it is defined that synchronization is confirmed when this numerical value becomes “2”.

A default of “0” is set to each of the specific addresses of instruction memories 112 and m/nb register files 115 and 116 that are shared, and array-type processor and MPU 200 that have completed data processing that uses this data memory read the above-described ì0î and write “1”. Then, because either array-type processor 100 or MPU 200 that executes succeeding stages of data processing reads “1” from data memory and updates the data to “2”, synchronization of data processing can be confirmed.

However, when executing data processing in the above-described method, array-type processor 100 and MPU 200 first read “0” from the data memory and then write “1”, and it is therefore possible for one processor to read “0” and write “1” during the time that the other processor reads “0” and writes “1”, in which case both processors will have written “1” and will remain in standby without ever confirming “2”.

In this case, memory controller 103 issues an atomic signal reporting the exclusive use of data memory to exclusive control circuit 401, and exclusive control circuit 401 replies to memory controller 103 with an acceptance or a refusal of this exclusive use. When one of array-type processor 100 and MPU 200 is using the data memory, the other's access to memory is refused, and exclusive use of the data memory can therefore be reliably conferred to array-type processor 100 and MPU 200.

A method that employs the above-described exclusive control circuit 401 necessitates both the addition of exclusive control circuits 401 to each of instruction memories 112 and m/nb register files 115 and 116 and the provision of more command buses 142, but can reduce the standby time for memory use by array-type processor 100 and MPU 200.

On the other hand, a method that employs the above-described synchronization control circuit 133 results in some increase in the standby time for memory use by array-type processor 100 and MPU 200 but can suppress increase in circuit scale. The two method described in the foregoing explanation both have advantages and disadvantages, and the various conditions should therefore be taken into consideration when implementing data processing system 1000 so as to select the most suitable method.

In the present working example, an example was described in which event data were communicated between synchronization control circuit 133 and state managing unit 105 by way of data path unit 106 in order to synchronize data processing of array-type processor 100 and MPU 200. However, it is also possible for synchronization control circuit 133 to directly issue the control signals of state managing unit 105 that correspond to the event data and for the state data of state managing unit 105 that correspond to the event data to be directly reported to synchronization control circuit 133.

In this case, the state of array-type processor 100 that is managed by state managing unit 105 can be directly reported to MPU 200, and the event data that are issued by MPU 200 can be directly reflected in the state of array-type processor 100 that is managed by state managing unit 105.

However, when a large number of items of event data are reported from MPU 200 to array-type processor 100 in this method, this number is limited by the number of operating states that can be held at state managing unit 105. Further, data path unit 106 does not participate in the data communication between synchronization control circuit 133 and state managing unit 105, and a means is therefore required for coordinating the event data that data path unit 106 issues to state managing unit 105 and the control signals that synchronization control circuit 133 reports to state managing unit 105.

In other words, this method also has advantages and disadvantages when compared to a method in which event data are mutually communicated between synchronization control circuit 133 and state managing unit 105 by way of data path unit 106 and a method that employs exclusive control circuit 401, and it is therefore best to take into consideration the various conditions and select appropriately when implementing data processing system 1000.

In addition, an example was described in the present working example in which synchronization control circuit 133 was positioned between memory access unit 132 and data path unit 106, but this synchronization control circuit 133 can be arranged in various positions as long as its function is realized. Further, although a case was described in the present working example in which the read/write data of instruction memories 112 and m/nb register files 115 and 116 were transmitted on command buses 142, these data may also be transmitted on m/nb buses 109 and 110.

Further, although an example was described in the present working example in which array-type processor 100 had the two types of circuit resources “mb” constituted by “8 bits” and “nb” constituted by “1 bit”, the number of types of circuit resources as well as the number of bits can be variously set.

Further, an example was described in the present working example in which switch elements 108 shared instruction memories 112 of the adjacent processor elements 107, and in which state managing unit 105 supplied the instruction pointers of one set of processor elements 107 and switch elements 108 to the instruction memory 112 of the corresponding processor element 107.

However, switch elements 108 may also have instruction memories for their own exclusive use that are separate from the instruction memories 112 of processor elements 107, and state managing unit 105 may separately supply the instruction pointers of processor elements 107 and switch elements 108 to the corresponding instruction memories 112 of processor element 107 and switch elements 108.

Alternatively, processor elements 107 may share the instruction memories of switch elements 108, and state managing unit 105 may supply instruction pointers of set of processor elements 107 and switch elements 108 to the instruction memory of the corresponding switch elements 108.

Further, an example of a construction was described in the present working example in which each portion of array-type processor 100 was arranged on a plane. However, a construction is also possible in which, for example, m/nb buses 109 and 110, switch elements 108, and processor elements 107 are formed by stacking in a laminated structure.

Finally, a case was described in the present working example in which only one state managing unit 105 was formed in array-type processor 100. However, a plurality of state managing units 105 may also be provided with one state managing unit 105 managing each group of a prescribed number of processor elements 107. In such a case, it is preferable that one state managing unit 105 that represents a plurality of state managing units 105 exercise integrated control, or that a superior managing unit (not shown in the figures) be formed for implementing integrated control of the plurality of state managing unit 105.

While a preferred embodiment of the present invention has been described using specific terms, such description is for illustrative purposes only, and it is to be understood that changes and variations may be made without departing from the spirit or scope of the following claims.

What is claimed is:

1. A data processing system in which a plurality of data processors are connected in parallel, said data processors performing processing, in accordance with a computer program that have been set beforehand and event data that are received as input, of process data that have been received as input; said data processing system distributing said process data among said plurality of data processors and processing said process data; wherein:
at least one of said plurality of data processors is constituted by an array-type processor, this array-type processor including:
a data path unit in which a plurality of processor elements, which individually execute data processing in accordance with instruction codes that have been individually set, and a plurality of switch elements, which individually switch-control the connection relations of the plurality of said processor elements in accordance with instruction codes that have been individually set, are arranged in a matrix; and
a state managing unit that successively switches contexts that are constituted by said instruction codes of said data path unit in accordance with said computer program and said event data;
at least a portion of process data that have been processed by other said data processors is transmitted to said data path unit of said array-type processor; and
at least a portion of process data that have been processed at said data path unit of said array-type processor is transmitted to other said data processors, and at least a portion of event data that have been generated by said data path unit in accordance with data processing is transmitted to other said data processors.

2. A data processing system in which a plurality of data processors are connected in parallel, said data processors performing processing, in accordance with computer programs that have been set beforehand and event data that are received as input, of process data that have been received as input; said data processing system distributing said process data among said plurality of data processors and processing said process data; wherein:
at least one of said plurality of data processors is constituted by an array-type processor, this array-type processor including:
a data path unit in which a plurality of processor elements, which individually execute data processing in accordance with instruction codes that have been individually set, and a plurality of switch elements, which individually switch-control the connection relations of the plurality of said processor elements in accordance with instruction codes that have been individually set, are arranged in a matrix; and
a state managing unit that successively switches contexts that are constituted by said instruction codes of said data path unit in accordance with said computer programs and said event data;
at least a portion of process data that have been processed by other said data processors is transmitted to said data path unit of said array-type processor, and at least a portion of event data that have been issued by other said data processors in accordance with said data processing is transmitted to said state managing unit; and
at least a portion of process data that have been processed at said data path unit of said array-type processor is transmitted to other said data processors.

3. A data processing system in which a plurality of data processors are connected in parallel, said data processors performing processing, in accordance with computer programs that have been set beforehand and event data that are received as input, of process data that have been received as input; said data processing system distributing said process data among said plurality of data processors and processing said process data; wherein:
at least one of said plurality of data processors is constituted by an array-type processor, this array-type processor including:
a data path unit in which a plurality of processor elements, which individually execute data processing in accordance with instruction codes that have been individually set, and a plurality of switch elements, which individually switch-control the connection relations of the plurality of said processor elements in accordance with instruction codes that have been individually set, are arranged in a matrix; and
a state managing unit that successively switches contexts that are constituted by said instruction codes of said data path unit in accordance with said computer programs and said event data;
at least a portion of process data that have been processed by other said data processors is transmitted to said data path unit of said array-type processor, and at least a portion of event data that have been issued by other said data processors in accordance with said data processing is transmitted to said state managing unit; and
at least a portion of process data that have been processed at said data path unit of said array-type processor is transmitted to other said data processors, and at least a portion of event data that have been generated by said data path unit in accordance with data processing is transmitted to other said data processors.

4. A data processing system according to claim 1, wherein said array-type processor includes a synchronization control circuit for executing at least one of:
storing, by means of said state managing unit, said event data that are read by other said data processors, and
storing, by means of other said data processors, said event data that are read by said state managing unit.

5. A data processing system according to claim 1, wherein:
said array-type processor includes data memory for temporarily storing various data in a freely updateable state,
said data memory being shared by said array-type processor and other said data processors.

6. A data processing system in which process data that have been received as input are distributed among a plurality of data processors that are connected in parallel and processed; wherein:
at least one of said plurality of data processors is constituted by an array-type processor, this array-type processor including:
a data path unit in which a plurality of processor elements, which individually execute data processing in accordance with instruction codes that have been individually set, and a plurality of switch elements, which individually switch-control the connection relations of said plurality of processor elements in accordance with instruction codes that have been individually set, are arranged in a matrix;
a state managing unit that successively switches contexts that are constituted by said instruction codes of said data path unit in accordance with said computer programs; and
a data memory for temporarily storing various data in a freely updateable state; and wherein said data memory is shared by said array-type processor and other said data processors.

7. A data processing system according to claim 6, wherein said array-type processor includes an exclusive control circuit for granting exclusive use of said data memory to one of said array-type processor itself and other said data processors.

8. A data processing system according to claim 6, wherein:
said data memory is constituted by a plurality of memory units that are distributed it said the data path unit, and
said array-type processor includes a virtual recognition means for causing other said data processors to recognize this plurality of memory units as a single said data memory.

9. A data processing system according to claim 8, wherein:
access ports for accepting data reading/writing and storage areas for each item of address data are each constituted by a plurality of multiport memories in at least a portion of said plurality of memory units; and
data reading/writing by said array-type processor and by other said data processors is accepted simultaneously at access ports and storage areas that differ from each other.

10. A data processing system according to claim 8, wherein:
at least a portion of said plurality of memory units are incorporated in at least a portion of said plurality of processor elements; and
when a portion of said plurality of the processor elements of said array-type processor are using said memory units, other said data processors use said memory units that are not being used in the remaining portion of said processor elements.

11. A data processing system according to claim 8, wherein:
at least a portion of said plurality of processor elements includes register files for temporarily holding process data, and
at least a portion of said plurality of memory units are constituted by said register files.

12. A data processing system according to claim 8, wherein:
at least a portion of said plurality of processor elements include instruction memories for temporarily holding said instruction codes in a freely updateable state; and
at least a portion of said plurality of memory units are constituted by said instruction memories.

13. A data processing system according to claim 8, wherein:
said array-type processor includes data buses that transmit process data of said plurality of processor elements and that are switch-controlled by means of said plurality of switch elements; and
at least a portion of said plurality of memory units are connected to said data buses in parallel with said processor elements.

14. A data processing system according to claim 8, wherein:
at least a portion of said plurality of processor elements include instruction memories for temporarily holding said instruction codes in a freely updateable state;
said array-type processor separately includes: data buses that are switch-controlled by means of said plurality of switch elements and that transmit process data of said plurality of processor elements; and command buses that transmit said instruction codes that have been received as input to said plurality of processor elements; and
read/write data of said memory units that are used by other said data processors are transmitted by said command buses.

15. A data processing system according to claim 14, wherein:
said state managing unit includes an instruction decoder for decoding address data of a large number of bits to a plurality of items of address data of a small number of bits that are necessary for data storage of said instruction codes in said instruction memories; and
said data processing system further includes: a small number of large-capacity buses for transmitting said address data of a large number of bits that have been received as input to said state managing unit; and
a large number of small-capacity buses for transmitting said address data of a small number of bits from said state managing unit as far as a plurality of said processor elements.

16. A data processing system according to claim 5, wherein said array-type processor separately includes:
an address generation circuit for issuing address data in accordance with data reading of said data memory by other said data processors; and
a data read circuit for outputting read data that have been read from said data memory by means of said address data that have been issued by this address generation circuit; and
wherein said address generation circuit and said data read circuit are arranged distributed on both sides of said data path unit.

17. An array-type processor of the data processing system according to claim 1, comprising:
a data path unit in which a plurality of processor elements, which individually execute data processing in accordance with instruction code that is individually set, and a plurality of switch elements, which individually switch-control the connection relations of said plurality of processor elements in accordance with instruction code that is individually set, are arranged in a matrix; and
a state managing unit for successively switching contexts that are constituted by said instruction codes of said data path unit in accordance with said computer program and said event data;
wherein at least a portion of process data that have been processed at other said data processors is transmitted to said data path unit, and said data path unit transmits at least a portion of process data that have been processed to other said data processors; and wherein said state managing unit transmits at least a portion of event data that have been generated by said data path unit in accordance with data processing to other said data processors.

18. An array-type processor of the data processing system according to claim 2, comprising:
a data path unit in which a plurality of processor elements, which individually execute data processing in accordance with instruction code that is individually set, and a plurality of switch elements, which individually switch-control the connection relations of said plurality of processor elements in accordance with instruction code that is individually set, are arranged in a matrix; and
a state managing unit for successively switching contexts that are constituted by said instruction code of said data path unit in accordance with said computer program and said event data;
wherein at least a portion of process data that have been processed at other said data processors is transmitted to said data path unit, and said data path unit transmits at least a portion of process data that have been processed to other said data processors; and at least a portion of the event data that have been issued by other said data processors in accordance with data processing is transmitted to said state managing unit.

19. An array-type processor of the data processing system according to claim 3, comprising:
a data path unit in which a plurality of processor elements, which individually execute data processing in accordance with instruction code that is individually set, and a plurality of switch elements, which individually switch-control the connection relations of said plurality of processor elements in accordance with instruction code that is individually set, are arranged in a matrix; and
a state managing unit for successively switching contexts that are constituted by said instruction code of said data path unit in accordance with said computer program and said event data;
wherein at least a portion of process data that have been processed at other said data processors is transmitted to said data path unit, and said data path unit transmits at least a portion of process data that have been processed to other said data processors; and at least a portion of event data that are issued by other said data processors in accordance with data processing are transmitted to said state managing unit, and said state managing unit transmits at least a portion of event data that said data path unit has generated in accordance with data processing to other said data processors.

20. An array-type processor of the data processing system according to claim 5, comprising
a data path unit in which a plurality of processor elements, which individually execute data processing in accordance with instruction code that is individually set, and a plurality of switch elements, which individually switch-control the connection relations of said plurality of processor elements in accordance with instruction code that is individually set, are arranged in a matrix;
a state managing unit for successively switching contexts that are constituted by said instruction code of said data path unit in accordance with said computer program;
data memory for temporarily storing various data in a freely updateable state; and
a memory sharing means for causing other said data processors to share said data memory.

21. A data processor that is one of other said data processors of the data processing system according to claim 1, comprising:
an information storage medium in which a computer program has been set beforehand;
a data input means for receiving as input process data and event data;
a data processing means for processing said process data that have been received as input in accordance with said computer program and said event data; and
a data output means for outputting process data that have been processed by this data processing means and event data;
wherein said data input means receives as input at least a portion of said process data and event data from said array-type processor;
said data processing means issues new event data in accordance with at least a portion of said data processing; and
said data output means outputs at least a portion of said process data to said array-type processor.

22. A data processor that is one of other said data processors of the data processing system according to claim 2, comprising:
an information storage medium in which a computer program has been set beforehand;
a data input means for receiving as input process data and event data;
a data processing means for processing said process data that have been received as input in accordance with said computer program and said event data; and
a data output means for outputting process data that have been processed by this data processing means and event data;
wherein said data input means receives as input at least a portion of said process data from said array-type processor;
said data processing means issues new event data in accordance with at least a portion of said data processing; and
said data output means outputs to said array-type processor at least a portion of said process data and said event data that have been newly issued.

23. A data processor that is one of other said data processors of the data processing system according to claim 3, comprising:
an information storage medium in which a computer program has been set beforehand;
a data input means for receiving as input process data and event data;
a data processing means for processing said process data that have been received as input in accordance with said computer program and said event data; and
a data output means for outputting process data that have been processed by this data processing means and event data;
wherein said data input means receives as input at least a portion of said process data and event data from said array-type processor;
said data processing means issues new event data in accordance with at least a portion of said data processing; and
said data output means outputs to said array-type processor at least a portion of said process data and said event data that have been newly issued.

24. A data processor that is one of other said data processors of the data processing system according to claim 6, comprising:
an information storage medium in which a computer program has been set beforehand;
a data input means for receiving process data as input;
a data processing means for processing, in accordance with said computer program, said process data that have been received as input at said data input means;
a data output means for outputting process data that have been processed by this data processing means; and
a data storage means for temporarily storing various data such as said process data;
wherein at least a portion of said various data is temporarily stored in the data memory of said array-type processor.

25. An array-type processor that is provided with a computer program for the array-type processor according to claim 17; said computer program causing said array-type processor to execute processes for:
causing said data path unit to receive as input at least a portion of process data that have been processed at other said data processors;
causing said data path unit to output at least a portion of process data that have been processed to other said data processors; and
causing said state managing unit to output to other said data processors at least a portion of event data that are generated by said data path unit in accordance with data processing.

26. An array-type processor that is provided with a computer program for the array-type processor according to claim 18, said computer program causing said array-type processor to execute processes of:
causing said data path unit to receive as input at least a portion of process data that have been processed at other said data processors;
causing said data path unit to output at least a portion of process data that have been processed to other said data processors; and
causing said state managing unit to receive as input at least a portion of event data that are issued by other said data processors in accordance with data processing.

27. An array-type processor that is provided with a computer program for the array-type processor according to claim 19, said computer program causing said array-type processor to execute processes for:
causing said data path unit to receive as input at least a portion of process data that have been processed at other said data processors;
causing said data path unit to output at least a portion of process data that have been processed to other said data processors;
causing said state managing unit to receive as input at least a portion of event data that are issued by other said data processors in accordance with data processing; and
causing said state managing unit to output to other said data processors at least a portion of event data that are generated by said data path unit in accordance with data processing.

28. An array-type processor that is provided with a computer program for the array-type processor according to claim 20, said computer program causing said array-type processor to execute a process for causing other said data processors to share said data memory.

29. A data processor that is provided with a computer program for the data processor according to claim 21, said computer program causing said data processor to execute processes for:
receiving as input from said array-type processor at least a portion of said process data and event data;
issuing new event data in accordance with at least a portion of said data processing; and
outputting to said array-type processor at least a portion of said process data.

30. A data processor that is provided with a computer program for the data processor according to claim 22, said computer program causing said data processor to execute processes for:
receiving as input from said array-type processor at least a portion of said process data;
issuing new event data in accordance with at least a portion of said data processing; and
outputting to said array-type processor at least a portion of said process data and said event data that have been newly issued.

31. A data processor that is provided with a computer program for the data processor according to claim 23, said computer program causing said data processor to execute processes for:
receiving as input from said array-type processor at least a portion of said process data and event data;
issuing new event data in accordance with at least a portion of said data processing; and
outputting to said array-type processor at least a portion of said process data and said event data that have been newly issued.

32. A data processor that is provided with a computer program for the data processor according to claim 24, said computer program causing said data processor to execute a process for temporarily storing in the data memory of said array-type processor at least a portion of said various data.

33. An information storage medium on which is stored a computer program according to claim 25; this being an information storage medium on which is stored a computer program for the array-type processor of the data processing system according to claim 1.

34. An information storage medium on which is stored a computer program according to claim 29;
this being an information storage medium on which is stored a computer program for other said data processors of the data processing system according to claim 1.
